(19) United States
(12) Patent Application Publication
(10) Pub. No.: US 2025/0299141 A1
(43) Pub. Date: Sep. 25, 2025

(54) MEASURING AND INCREASING OPERATIONAL MATURITY

(71) Applicant: Kyndryl, Inc., New York, NY (US)

(72) Inventors: Umar Mohamed Iyoob Umar, Pflugerville, TX (US); Omar Odibat, Cedar Park, TX (US); Keri Wheatley, Sevierville, TN (US)

(21) Appl. No.: 18/609,139

(22) Filed: Mar. 19, 2024

(51) Int. Cl. G06Q 10/0637; G06Q 10/0639

(52) U.S. Cl. CPC G06Q 10/06375; G06Q 10/06393

(57) ABSTRACT

A computer-implemented method that includes obtaining a plurality of data types from an aggregation of data sources, generating at least one capability maturity score by evaluating a capability of at least one data source of the aggregation of data sources, and generating at least one provider maturity score by evaluating at least one data source of the aggregation of data sources associated with a specific provider. The method may further include generating, using a machine learning algorithm, a set of recommendations by iteratively simulating a plurality of modified capabilities and determining one or more steps to increase operational maturity. The method may further include ranking the set of recommendations and preparing a report for a user, including an explanation of the predicted change in the operational maturity in response to implementing the set of recommendations.

### BACKGROUND

Aspects of the present invention relate generally to operational management and, more particularly, to measuring operational maturity, creating Key Performance Indicators (KPIs), and providing recommendations to improve operational maturity.

Operational management is the practice of optimizing operational processes and resources in cloud-based environments to achieve cost efficiency and align goals with objectives. Operational management is a public cloud management discipline that enables organizations to get maximum value from the cloud by helping technology, finance, and business teams to collaborate on data-driven spending decisions. Many businesses use operational management to try to reduce overall cloud computing costs while still achieving business goals.

### SUMMARY

In a first aspect of the invention, there is a computer-implemented method including: obtaining, by a computing device, a plurality of data types from an aggregation of data sources; generating, by the computing device, at least one capability maturity score by evaluating a capability of at least one data source of the aggregation of data sources; generating, by the computing device, at least one provider maturity score by evaluating the at least one data source of the aggregation of data sources associated with a specific provider; generating, by the computing device using a machine learning algorithm, a set of recommendations based on a combination of the at least one capability maturity score and the at least one provider maturity score by iteratively simulating a plurality of modified capabilities and determining one or more steps to increase an operational maturity; ranking, by the computing device, the set of recommendations based at least partially on a predicted change in the operational maturity in response to implementing the set of recommendations; and preparing, by the computing device, a report for a user, the report comprising a determined explanation of the predicted change in the operational maturity in response to implementing the set of recommendations.

In another aspect of the invention, there is a computer program product including one or more computer readable storage media having program instructions collectively stored on the one or more computer readable storage media. The program instructions are executable to: obtain a plurality of data types from an aggregation of data sources; segment the plurality of data types; generate at least one capability maturity score by evaluating a capability of at least one data source of the aggregation of data sources; generate at least one provider maturity score by evaluating a provider associated with the at least one data source of the aggregation of data sources associated with a specific provider; generate, using a machine learning algorithm, a set of recommendations based on a combination of the at least one capability maturity score and the at least one provider maturity score by iteratively simulating a plurality of modified capabilities and determining one or more steps to increase an operational maturity; rank the set of recommendations based at least partially on a predicted change in the operational maturity in response to implementing the set of recommendations; and prepare a report for a user, the report comprising an a determined explanation of the predicted change in the operational maturity in response to implementing the set of recommendations.

In another aspect of the invention, there is a system including a processor, a computer readable memory, one or more computer readable storage media, and program instructions collectively stored on the one or more computer readable storage media. The program instructions are executable to: obtain a plurality of data types from an aggregation of data sources; segment the plurality of data types; generate at least one capability maturity score by evaluating a capability of at least one data source of the aggregation of data sources; generate at least one provider maturity score by evaluating a provider associated with the at least one data source of the aggregation of data sources associated with a specific provider; generate, using a machine learning algorithm, a set of recommendations based on a combination of the at least one capability maturity score and the at least one provider maturity score by iteratively simulating a plurality of modified capabilities and determining one or more steps to increase an operational maturity; rank the set of recommendations based at least partially on a predicted change in the operational maturity in response to implementing the set of recommendations; and prepare a report for a user, the report comprising an a determined explanation of the predicted change in the operational maturity in response to implementing the set of recommendations.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

FIG. 6 shows a flowchart of an exemplary method in accordance with aspects of the invention.

FIG. 7 shows report data of an exemplary method in accordance with aspects of the invention.

FIG. 8 shows a calculation table of an exemplary method in accordance with aspects of the invention.

FIG. 9 shows a calculation table of an exemplary method in accordance with aspects of the invention.

### DETAILED DESCRIPTION

Aspects of the present invention relate generally to operational management and, more particularly, to measuring operational maturity, creating Key Performance Indicators (KPIs), and providing recommendations to improve operational maturity. According to aspects of the invention the system may be generally configured to measure operational maturity, make recommendations for improving/increasing an organization's operational maturity, and explain the recommendations and/or a score associated with the operational maturity. As an example, the operational maturity comprises financial operational maturity.

According to an aspect of the invention, there is a computer-implemented method for evaluating operational maturity, the method including: obtaining a plurality of data types from an aggregation of data sources within one or more cloud computing environments; segmenting the plurality of data types according to one or more of industry, age, or volume; evaluating the data segments by cloud computing environment and capability of data source, the evaluation generating a maturity score; in response to the evaluation, ranking, based at least partially on a predicted change in maturity score, a set of recommendations generated to increase operational maturity; determining a set of weighted contributions, the set of weighted contributions having been used to generate the maturity score, where the set of weighted contributions correlate to the predicted increase in operational maturity; and preparing a report for a user, the report explaining a significance of the set of weighted contributions and the correlated predicted increase in operational maturity.

According to another aspect of the invention, the plurality of data types includes one or more of account data, cost data, usage data, asset metadata, monitoring data, tag data, optimization recommendation data, right-size recommendation data, auto-tag recommendation data, coverage recommendation data, discount plan data, forecast data, anomaly data, budged data, granularity data, or legacy system data. According to another aspect of the invention, the foregoing set of weighted contributions includes a change in one or more features of the plurality of data types used in the evaluation.

Over time, more and more companies and organizations rely on cloud computing to carry out their business purposes. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Companies continue to overspend and/or underutilize the resources that are available to them because the existing technologies for reporting cloud-computing use are inadequate.

Furthermore, known systems for reporting cloud-computing lack the specificity to help an organization (e.g., company, entity) measure and/or improve its use of the cloud-computing resources (i.e. improve its operational maturity). Without an adequate system to measure operational maturity, companies are stuck in a cycle of overspending and/or underutilizing because they do not know the maturity of their operations. Similarly, without an adequate system for reporting recommended steps for improving operational maturity, organizations may learn that their systems are not yet mature. Accordingly, organizations are stuck in a cycle of overspending and/or underutilizing resources because the organization is unaware of specific steps which can improve operational maturity.

Embodiments and aspects of the invention provide a system and method that improves and advances the technology in a specific and practical application. In other words, embodiments and aspects of the invention improve an entity's ability to measure and improve its operational maturity. For example, according to aspects of the invention, the system and method may obtain a plurality of data types from an aggregation of data sources, generate at least one capability score and at least one provider maturity score, and generate a set of recommendations based on a combination of the at least one capability maturity score and the at least one provider maturity score by iteratively simulating a plurality of modified capabilities and determining one or more steps to increase an operational maturity. According to additional aspects of the invention, the system and method may further rank the set of recommendations based at least partially on a predicted change in the operational maturity in response to following the set of recommendations. Each of these aspects, alone and in combination, help improve an organization's ability to measure and improve operational maturity (i.e., save on costs and better utilize the available cloud-computing resources).

Implementations of the invention are necessarily rooted in computer technology. For example, at least generating, using a machine learning algorithm, a set of recommendations based on a combination of the at least one capability maturity score and the at least one provider maturity score by determining one or more steps to increase an operational maturity, is computer-based, is very complex, and cannot be performed in the human mind. Given the scale and complexity required to perform the foregoing tasks, it is simply not possible for the human mind, or for a person using pen and paper, to perform the number of calculations involved in performing a deep learning (DL) algorithm, an extreme gradient boosting (EGBoost) algorithm, a support vector machine (SVM) algorithm, and/or a logistic regression algorithm.

Furthermore, using a machine learning model is, by definition, performed by a computer and cannot practically be performed in the human mind (or with pen and paper) due to the complexity and massive amounts of calculations involved. Given this scale and complexity, it is simply not possible for the human mind, or for a person using pen and paper, to perform the number of calculations involved in using a machine learning model.

It should be understood that, to the extent implementations of the invention collect, store, or employ personal information provided by, or obtained from, individuals (for example, any cloud managed data that may include personal information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

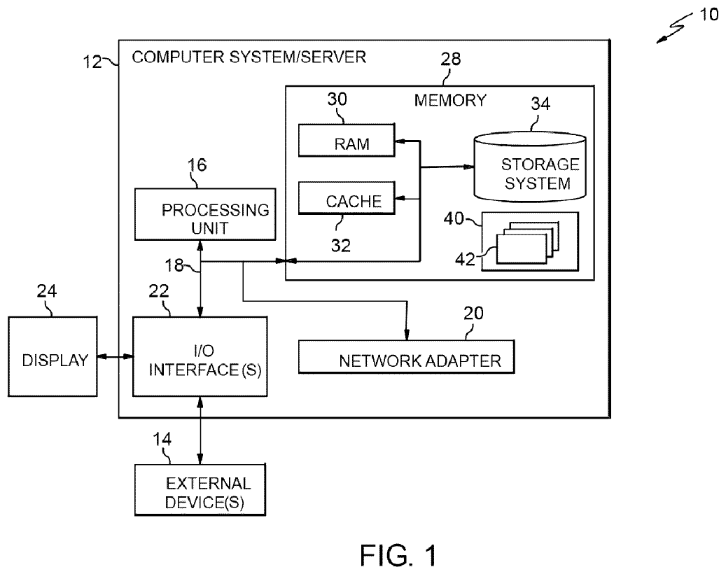

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

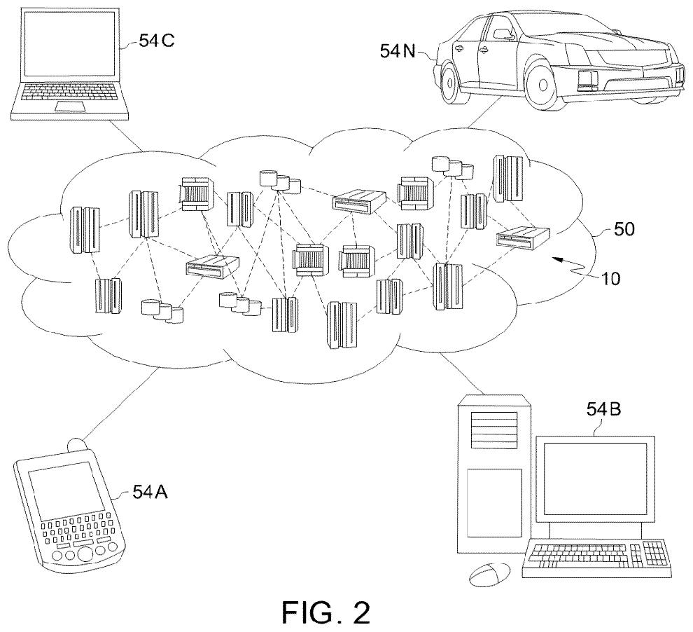

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

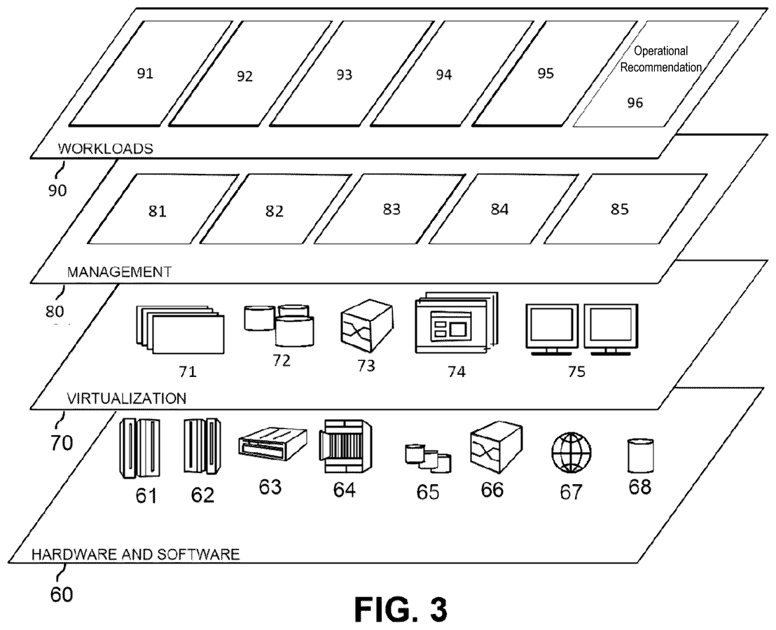

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and operational recommendation 96.

Implementations of the invention may include a computer system/server 12 of FIG. 1 in which one or more of the program modules 42 are configured to perform (or cause the computer system/server 12 to perform) one of more functions of the operational recommendation 96 of FIG. 3. For example, the one or more of the program modules 42 may be configured to: obtain a plurality of data types from an aggregation of data sources; segment the plurality of data types; generate at least one capability maturity score by evaluating a capability of at least one data source of the aggregation of data sources; generate at least one provider maturity score by evaluating a provider associated with the at least one data source of the aggregation of data sources associated with a specific provider; generate, using a machine learning algorithm, a set of recommendations based on a combination of the at least one capability maturity score and the at least one provider maturity score by iteratively simulating a plurality of modified capabilities and determining one or more steps to increase an operational maturity; rank the set of recommendations based at least partially on a predicted change in the operational maturity in response to implementing the set of recommendations; and prepare a report for a user, the report comprising an a determined explanation of the predicted change in the operational maturity in response to implementing the set of recommendations.

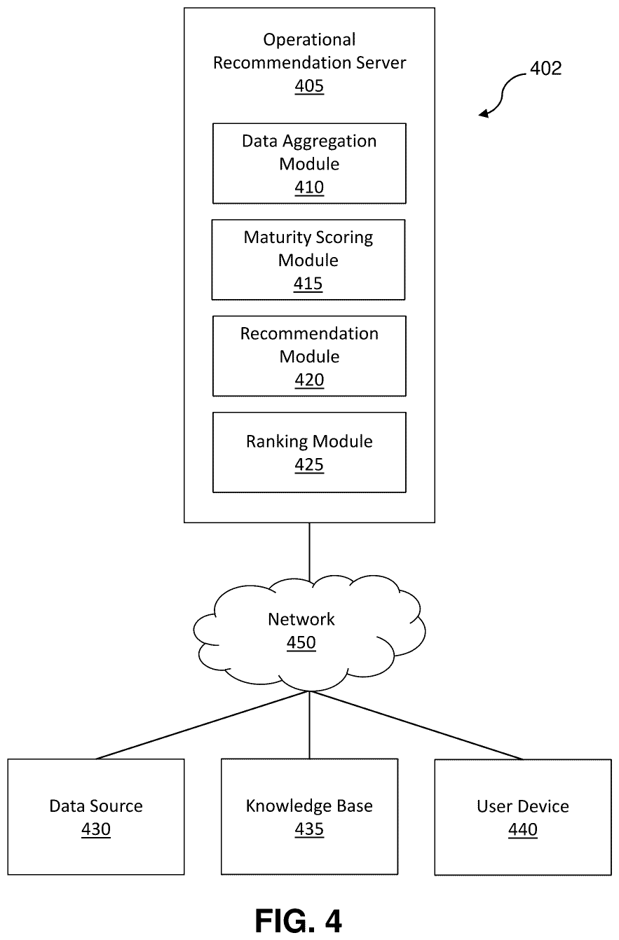

FIG. 4 shows a block diagram of exemplary environment 402 in accordance with aspects of the invention. In embodiments, the environment includes operational recommendation server 405, data source 430, knowledge base 435, user device 440, and network 450.

Operational recommendation server 405 may comprise one or more instances of computer system/server 12 of FIG. 1. In another example, operational recommendation server 405 may comprise one or more virtual machines or containers running on one or more instances of computer system/server 12 of FIG. 1. In embodiments, operational recommendation server 405 communicates with data source 430, knowledge base 435, and user device 440 via network 450, which may comprise cloud computing environment 50 of FIG. 2. In embodiments, data source 430 comprises one or more instances of hardware and software components of hardware and software layer 60 of FIG. 3. In embodiments, knowledge base 235 comprises one or more instances of hardware and software components of hardware and software layer 60 of FIG. 3. In embodiments, user device 440 comprises an instance of an end user device such as, for example, personal digital assistant (PDA) or cellular telephone 54A, desktop computer 54B, laptop computer 54C, and/or automobile computer system 54N of FIG. 2. In embodiments, there may be plural different instances of user device 440. The different instances of user device 440 may be used by different users and evaluators, respectively.

In embodiments, operational recommendation server 405 comprises data aggregation module 410, maturity scoring module 415, recommendation module 420, and ranking module 425, each of which may comprise one or more program modules such as program modules 42 described with respect to FIG. 1. Operational recommendation server 405 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In accordance with aspects of the invention, data aggregation module 410 may configured to obtain a plurality of data types from an aggregation of data sources. That is, data aggregation module 410 may collect data having one or more particular data types from a combination (i.e., aggregation) of one or more of the cloud computing environments. In embodiments, data aggregation module 410 segments the plurality of data types by industry, age, volume, and/or any other segment that might be useful for dividing/segmenting data. In embodiments, the data is segmented by cloud computing providers, to later determine an operational maturity score by provider. In embodiments, the data is segmented by cloud computing capability, to later determine an operational maturity score by capability.

In embodiments, maturity scoring module 415 may be configured to generate at least one capability maturity score by evaluating a capability of at least one data source of the aggregation of data sources or by evaluating a capability of the at least one data source within the segmented plurality of data types. Maturity scoring module 415 may also be configured to generate at least one provider maturity score by evaluating a provider associated with the data source of the aggregation of data sources or by evaluating a provider associated with the data source(s) within the segmented plurality of data types. For example, the provider maturity score provides a score for how well an organization utilizes the resources provided by a specific provider. This may be beneficial when an organization uses multiple providers because it provides additional insight on how well the resources are being used with each provider. The system will later use this score to determine possible steps (e.g., recommendations) to improve an organization's functional maturity.

In embodiments, operational maturity may be given a numerical score where 0 (zero) is the lowest and 100 (one hundred) is the highest. The numerical scores may be further (or alternatively) classified as a crawl, a walk, or a run. For example, in embodiments, a crawl may be classified based on a numerical score between zero and a variable “X,” a walk may be classified based on a numerical score between X+1 and a variable “Y,” and a run may be classified based on a numerical score between Y+1 and 100, where X and Y are integers between 1 and 99 and are selected by a subject matter expert (SME) based on a customer's goals, a data type, a provider, or another data point that may provide the system and/or customer an ability to measure and track its operational maturity. Thus, the set of recommendations provided by data aggregation module 410 may comprise one or more steps that, if followed, may increase a customer's operational maturity by transition from crawl to walk or from walk to run.

In embodiments, recommendation module 420 may be configured to generate, using a machine learning algorithm, a set of recommendations based on a combination of the at least one capability maturity score and the at least one provider maturity score. In embodiments, the machine learning algorithm used to generate the set of recommendations may be a support vector machine (SVM) algorithm or a logistic regression algorithm. In embodiments, the machine learning algorithm may test/simulate one or more new/modified capabilities to determine whether the one or more new/modified capabilities would positively (or negatively) affect an overall functional maturity for an organization. In embodiments, the machine learning algorithm repeats this process until an optimized set of recommendations is generated. As used herein, an optimized set of recommendations is a set of recommendations that will affect the largest change(s) to improve an organization's operational maturity. In embodiments, the machine learning algorithm may repeat the foregoing process until a threshold is reached. For example, an organization may indicate that it wishes to advance its functional maturity from a crawl to a walk. In such scenarios, the machine learning algorithm may generate a set of recommendations to achieve the organization's objective.

Recommendation module 420 may also determine at least one weighted contribution that correlates to the predicted change in the operational maturity in response to implementing the set of recommendations. According to aspects of the invention, the weighting of the weighted contribution may be determined based on a distribution weight. In embodiments, the distribution weight comprises distributions of features sampled across organizations at each operational maturity stage. In embodiments, the distribution weight may further consider standard deviations (e.g., higher feature weight given to features with higher standard deviations). In such embodiments, a higher standard deviation may indicate a higher relevance of a feature for determining operational maturity because it may decrease the effect of feature outliers in an overall score.

According to aspects of the invention, the weighting of the weighted contribution may be determined by a subject matter expert (SME). In other words, an SME would analyze the data and would assign a weighting based on the relevance of the data in determining operational maturity. For example, a cloud practitioner or a cloud architect may look at the industry, revenue, and other data types described herein, and the SME may determine the data and/or feature importance. The cloud practitioner or architect may then assign a weighting based on the determined feature importance. In additional embodiments, the weighting of the weighted contribution may be determined using a machine learning model that combines the distribution weight and the SME-determined weight to generate a final combined weighting for the weighted contribution. In embodiments, the weighting of the weighted contribution is determined a machine learning algorithm such as a deep learning (DL) algorithm or an extreme gradient boosting (EGBoost) algorithm.

In embodiments, ranking module 425 may be configured to rank the set of recommendations based at least partially on the predicted change in the operational maturity in response to implementing the set of recommendations. In other words, ranking module 425 may rank each recommendation of the set of recommendations based on which recommendation will cause the largest increase to the operational maturity. For instance, in an overly simple example, if one recommendation would increase a specific operational maturity index/score by 5 points and a second recommendation would increase a specific operational maturity index/score by 9 points, ranking module 425 would rank the second recommendation higher than the first recommendation. In embodiments, ranking module 425 ranks the set of recommendations based on the weighted contribution described above. In this manner, the weighted contribution directly influences the operational maturity.

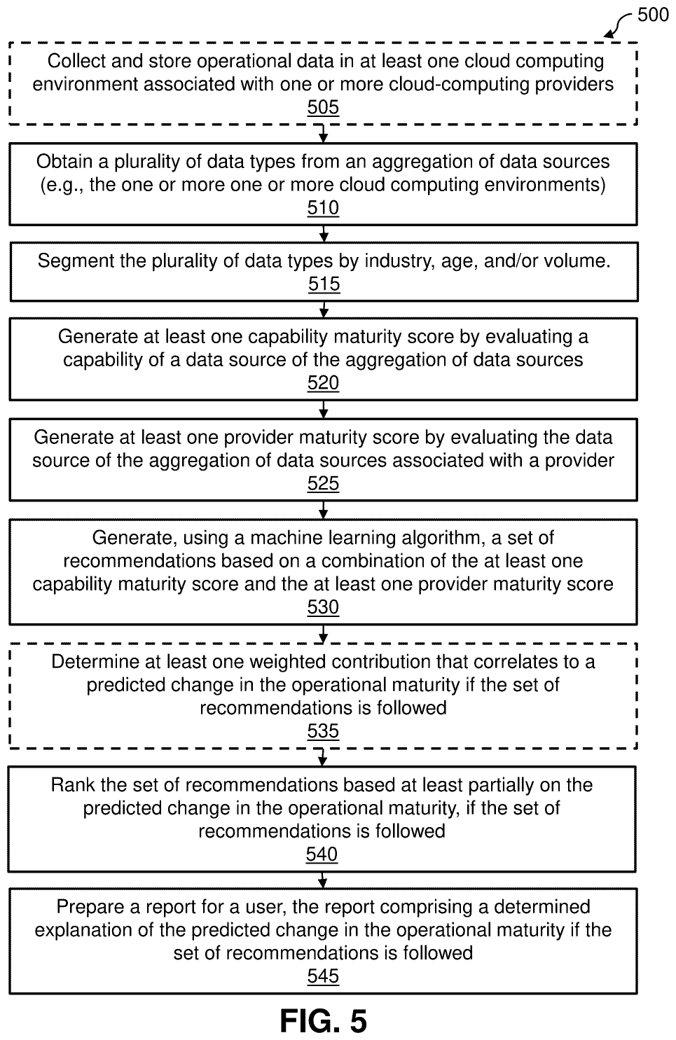

FIG. 5 shows a flowchart of an exemplary method 500 in accordance with aspects of the present invention. Steps of the method may be carried out in the environment of FIG. 4 and are described with reference to elements depicted in FIG. 4.

At block 505, operational recommendation server 405 of FIG. 4 is optionally configured to collect and store the obtained and/or collected operational data in at least one cloud computing environment associated with one or more cloud-computing providers. A cloud computing environment, as used herein, is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. For example, in embodiments, customers may subscribe to a provider's cloud computing services such as servers, applications, tools, storage, databases, and use and/or access those services over a network.

At block 510, data aggregation module 410 of FIG. 4 obtains a plurality of data types from an aggregation of data sources. In other words, data aggregation module 410 may collect data having one or more particular data types from a combination (i.e., aggregation) of one or more of the cloud computing environments. As used herein, data types may comprise one or more of the following:
Account data—how many accounts, account metadata, providers, provider and asset accounts, billing accounts, subscriptions, how the cost of the account breaks down, etc.
Cost data—the cost related to each of the accounts.
Usage data—measures/describes how well an entity is utilizing its resources.
Asset metadata—metrics that can be pulled from a cloud-computing provider that is specific to metadata describing a virtual machine.
Monitoring data—data that measures/describes how an asset is being monitored, how often assets are being used, users that last accessed data, a number of users that accessed data, etc.
Tag data—data tags that indicate a purpose, an environment, product development, a reason for the project the data belongs to, etc.
Optimization recommendation data—determine/measure how well an entity is acting on recommendations that have been made, including right-size recommendation data, auto-tag recommendation data, coverage recommendation data, etc.
Discount plan data—measures/determines discount plans that are available to an entity and/or an entity's utilization of discount plans that are available to it.
Forecast data—determining an entity's forecast and measuring/determining how close the entity is to their forecast.
Anomaly data—measures/determines how an entity is tracking its forecast data and/or budget.
Budgeted data—determining an entity's budget and measuring/determining how close the entity is to their budget.
Granularity data—measures/determines how deep the data is. For example, measuring the depth of cost data may measure/determine whether the cost data is being analyzed on a daily, weekly, or monthly timeframe.
Legacy system data—data that is not part of the cloud-computing environment but is at least partially integrated into the overall system.

At block 515, data aggregation module 410 segments the plurality of data types that were obtained and/or collected at the aggregation of data sources. In embodiments, the data types may be segmented by industry, age, volume, and/or any other segment that might be useful for dividing/segmenting data.

At block 520, maturity scoring module 415 of FIG. 4 generates at least one capability maturity score by evaluating a capability of at least one data source of the aggregation of data sources or by evaluating a capability of the data source(s) within the segmented plurality of data types. In embodiments, maturity scoring module 415 may generate a data score by evaluating a capability of the data source(s) without the use of a machine learning algorithm, before generating the capability maturity score. In embodiments, at least one capability maturity score is generated using a machine learning algorithm such as a DL algorithm or an EGBoost algorithm. In other words, the machine learning algorithm evaluates the capabilities of the data sources to determine a score for the capabilities. In embodiments, evaluating the capability of at least one data source of the aggregation of data sources or by evaluating a capability of the data source(s) may include evaluating the capabilities of each of the data sources.

As used herein, capabilities of the data source(s) may comprise cost allocation, data analysis and showback, managing anomalies, managing shared cost, forecasting, budget management, workload management and automation, managing commitment based discounts, resource utilization and efficiency, measuring unit costs, data ingestion and normalization, chargeback and finance integration, onboarding workloads, establishing an operations culture, operations and intersecting frameworks, cloud policy and governance, operations education and enablement, establishing an operations decision and accountability structure, etc. In embodiments, the capabilities may be further broken down into features. For example, the cost allocation capability may comprise features such as tagged assets, assets per asset account, naming and metadata standards, legacy assets not on a cloud, and more. Furthermore, the capabilities and/or features may further comprise a formula for calculating a numerical score for the capability and/or feature. For example, the assets per asset account feature may be calculated by dividing a number of accounts were an Asset:Account Ratio is greater than 5000:1 by a total number of accounts. In embodiments, the calculation may further include a weighted coefficient (or variable) that may modify the final outcome of the formula. In embodiments, the features may be categorized by a type of feature such as percentage, rule-based, Boolean, and/or normalized value features.

At block 525, maturity scoring module 415 of FIG. 4 generates at least one provider maturity score by evaluating a provider associated with at least one data source of the aggregation of data sources or by evaluating a provider associated with the data source(s) within the segmented plurality of data types. In embodiments, the provider maturity score may comprise calculating the capabilities and features, as described above, for a specific provider. In embodiments, at least one provider maturity score is generated using a machine learning algorithm such as a DL algorithm or EGBoost algorithm. In other words, the machine learning algorithm evaluates the provider (e.g., the cloud computing provider) associated with the data sources (e.g., cloud computing environment) to determine a score for the provider. In embodiments, maturity scoring module 415 may generate a data score by evaluating the provider of the data source(s) without the use of a machine learning algorithm, before generating the provider maturity score.

At block 530, recommendation module 420 of FIG. 4 generates, using a machine learning algorithm, a set of recommendations based on a combination of the at least one capability maturity score and the at least one provider maturity score. In embodiments, the machine learning algorithm used to generate the set of recommendations may be a support vector machine (SVM) algorithm or a logistic regression algorithm. As used herein, the set of recommendations may comprise one or more steps that, if followed, increase the operational maturity.

As used herein in block 530, operational maturity may be given a numerical score where 0 (zero) is the lowest and 100 (one hundred) is the highest. The numerical scores may be further (or alternatively) classified as a crawl, a walk, or a run. For example, in embodiments, a crawl may be classified based on a numerical score between zero and a variable “X,” a walk may be classified based on a numerical score between X+1 and a variable “Y,” and a run may be classified based on a numerical score between Y+1 and 100, where X and Y are integers between 1 and 99 and are selected by a subject matter expert (SME) based on a customer's goals, a data type, a provider, or another data point that may provide the system and/or customer an ability to measure and track its operational maturity. Thus, the set of recommendations provided by data aggregation module 410 may comprise one or more steps that, if followed, may increase a customer's operational maturity by transition from crawl to walk or from walk to run.

At block 535, recommendation module 420 of FIG. 4 may optionally determine at least one weighted contribution that correlates to the predicted change in the operations maturity in response to the set of recommendations being followed. In embodiments, the weighted contribution comprises a change in one or more features of the plurality of data types.

According to aspects of the invention, the weighting of the weighted contribution may be determined based on a distribution weight. In embodiments, the distribution weight comprises distributions of features sampled across organizations at each operational maturity stage. In embodiments, the distribution weight may further consider standard deviations (e.g., higher feature weight given to features with higher standard deviations). In such embodiments, a higher standard deviation may indicate a higher relevance of a feature for determining operational maturity because it may decrease the effect of feature outliers in an overall score.

According to aspects of the invention, the weighting of the weighted contribution may be determined by a subject matter expert (SME). In other words, an SME would analyze the data and would assign a weighting based on the relevance of the data in determining operational maturity. For example, a cloud practitioner or a cloud architect may look at the industry, revenue, and other data types described herein, and the SME may determine the data and/or feature importance. The cloud practitioner or architect may then assign a weighting based on the determined feature importance. In additional embodiments, the weighting of the weighted contribution may be determined using a machine learning model that combines the distribution weight and the SME-determined weight to generate a final combined weighting for the weighted contribution. As provided above, in embodiments, the weighting of the weighted contribution is determined a machine learning algorithm such as a deep learning (DL) algorithm or an extreme gradient boosting (EGBoost) algorithm.

At block 540, ranking module 425 of FIG. 4 ranks the set of recommendations based at least partially on the predicted change in the operational maturity in response to the set of recommendations being followed. In other words, ranking module 425 may rank each recommendation of the set of recommendations based on which recommendation will cause the largest increase to the operational maturity. For instance, in an overly simple example, if one recommendation would increase a specific operational maturity index/score by 5 points and a second recommendation would increase a specific operational maturity index/score by 9 points, ranking module 425 would rank the second recommendation higher than the first recommendation. In embodiments, ranking module 425 ranks the set of recommendations based on the weighted contribution described above. In this manner, the weighted contribution directly influences the operational maturity.

At block 545, operational recommendation server 405 prepares a report for a user. In an example, the report comprises an explanation of the predicted change in the operational maturity in response to implementing the set of recommendations. In embodiments, the report may comprise the numerical operations maturity score, which may be normalized (e.g., in a range of 0-100). In embodiments, the report may further (or alternatively) comprise a set of features that could explain the model score. In other words, the report may explain whether a feature is high or low and explain why it is high or low. The report may further include an explanation for how the recommendations would increase or lower a feature or set of features. In another embodiment, the report may also (or alternatively) explain the significance of the weighted contribution. In other words, the report may explain why the feature was given/assigned its weighting and how the weighting affected the operations maturity.

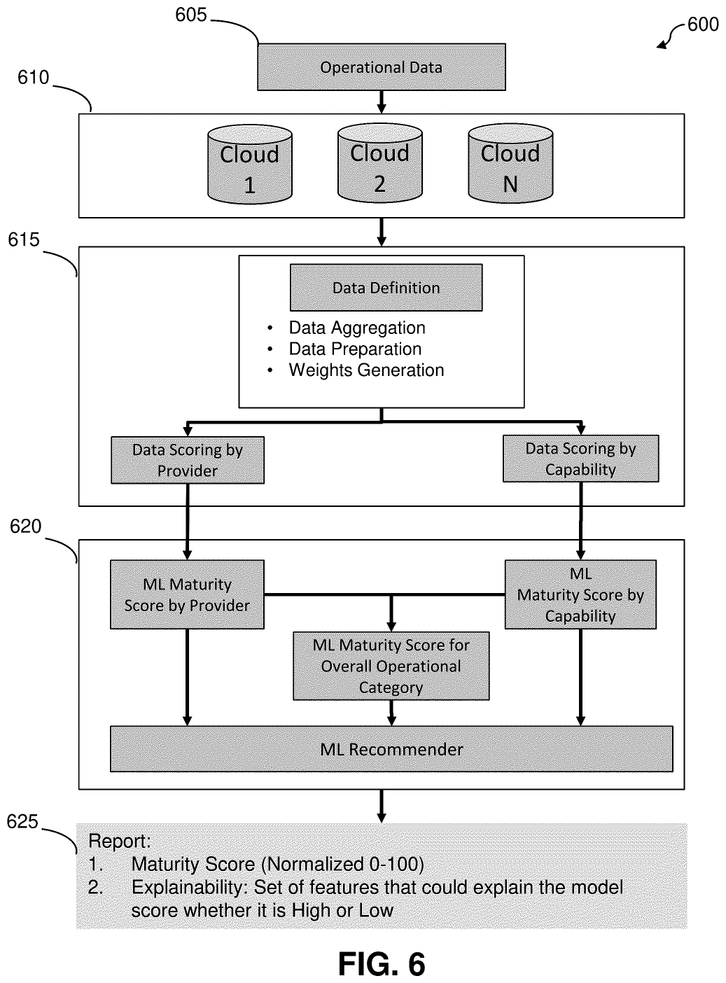

FIG. 6 shows a flowchart of an exemplary method 600 in accordance with aspects of the present invention. Steps of the method may be carried out in the environment of FIG. 4 and may include one or more blocks, as described with respect to method 500 of FIG. 5.

At block 610, operational data 605 is collected and stored in at least one cloud computing environment associated with one or more cloud-computing providers (e.g., Cloud 1, Cloud 2, and/or Cloud 3). As explained above, operational data may include one or more of account data, cost data, usage data, asset metadata, monitoring data, tag data, recommendation data (e.g., optimize data, right-size data, auto-tag data, and coverage data), discount plan data, forecast data, anomaly data, budget data, and granularity data, legacy system data.

At block 615, the plurality of data types that are collected and stored with one or more cloud-computing providers may be aggregated and prepared (e.g., segmented by industry, age, volume) for further processing. Furthermore, distribution weighting and SME weighting may be applied to the data in accordance with the methods described with respect to FIG. 5. As shown, block 615 further comprises generating data scores by providers and by capabilities.

At block 620, machine learning algorithms are used to generate maturity scores by providers and by capabilities in accordance with the methods described with respect to FIG. 5. The system generates a maturity score for one or more overall operational categories using the generated maturity score. Using the scores as input, a machine learning algorithm may create/generate a set of recommendations based on a combination of the at least one capability maturity score and the at least one provider maturity score. In embodiments, the machine learning algorithm used to generate the set of recommendations may be an SVM algorithm or a logistic regression algorithm. As used herein, the set of recommendations may comprise one or more steps that, if followed, increase the operational maturity.

At block 625, prepares a report for a user. In embodiments, the report comprises an explanation of the predicted change in the operational maturity in response to implementing the set of recommendations. As described above, the report may comprise the numerical operational maturity score. The report may further comprise a set of features that could explain the model score. In other words, the report may explain whether a feature is high or low and explain why it is high or low. The report may further include an explanation for how the recommendations would increase or lower a feature or set of features in accordance with the methods described with respect to FIG. 5.

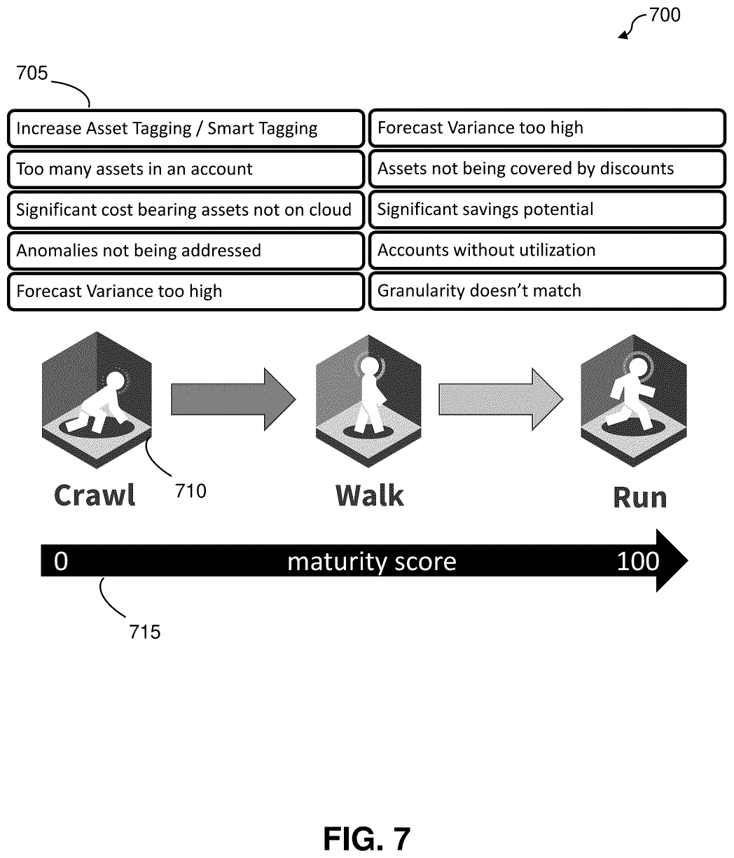

FIG. 7 shows exemplary report data 700 in accordance with embodiments described herein. FIG. 7 illustrates a set of recommendations 705 that may increase or lower operational maturity score 715, such that the maturity score/status 710 may transition from crawl to walk or walk to run. In embodiments, recommendations 705 may be generated, at least in part, using the methods described with respect to one or more of blocks 530, 535, and/or 540 of FIG. 5. In embodiments, operational maturity score 715 may be generated, at least in part, using the methods described with respect to one or more of blocks 520, 525, 530, 535, and/or 540 of FIG. 5.

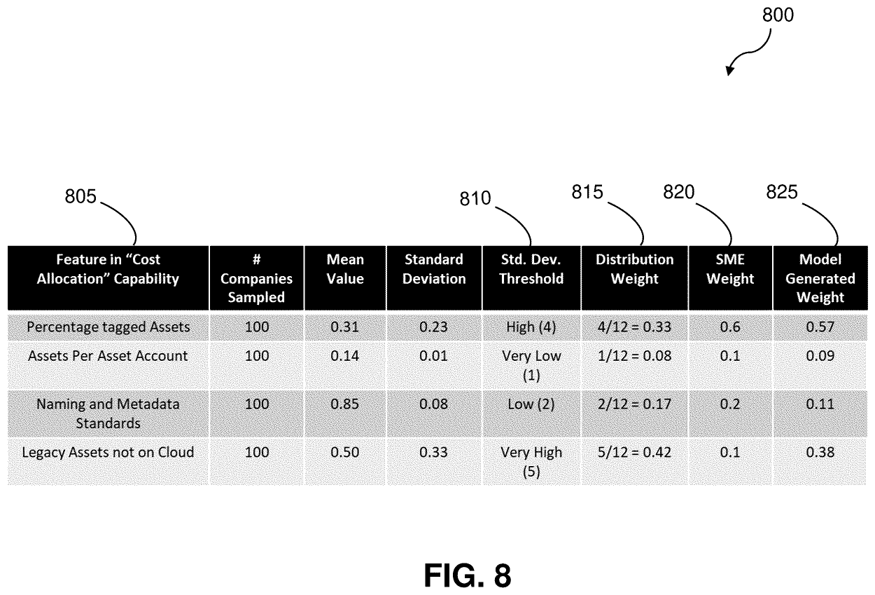

FIG. 8 shows an exemplary calculation table 800 for calculating a feature weighting in accordance with embodiments described herein. Specifically, FIG. 8 illustrates an exemplary weighting calculation for “cost allocation” capability 805. Further, as described above with respect to block 535 of FIG. 5, recommendation module 420 of FIG. 4 may determine at least one weighted contribution that correlates to the predicted change in the operational maturity in response to implementing the set of recommendations.

According to aspects of the invention, model generated weight 825 is generated by a machine learning model that uses a standard deviation threshold 810, distribution weight 815, and SME weight 820 as inputs. In embodiments, model generated weight 825 may be determined using a machine learning model that uses distribution weight 815 and SME weight 820 as inputs to generate a final combined model generated weight 825. In embodiments, as described above, a distribution weight may consider standard deviation thresholds 810 (e.g., higher feature weight given to features with higher standard deviations). In particular, distribution weight 815 is calculated by dividing standard deviation threshold 810 by a number of assets, e.g., 12. As described above, SME weight 820 may be assigned by a cloud practitioner or architect based on the determined feature importance.

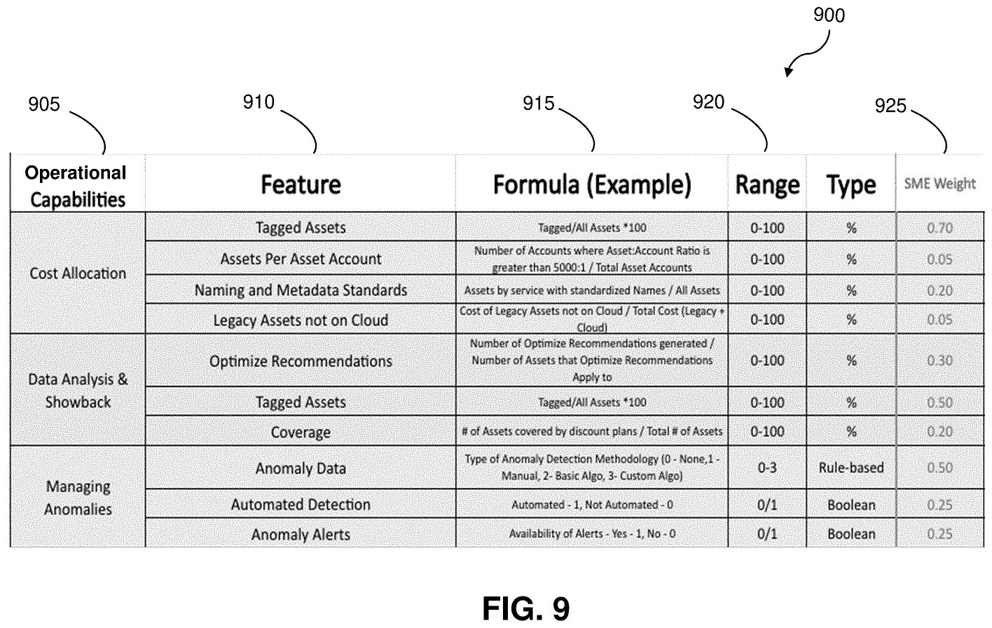

FIG. 9 shows an exemplary calculation table 900 in accordance with embodiments described herein. Specifically, FIG. 9 illustrates an exemplary method for data preparation and feature engineering for operational capabilities 905, including features 910 each associated with respective operational capabilities 905.

In embodiments, operational capabilities 905 may be broken down into features 910. For example, the “data analysis & showback” capability may comprise features such as optimize recommendations, tagged assets, and coverage. Furthermore, each capability and feature may further comprise a formula (example) 915 for calculating a numerical score within range 920 for the capability and/or feature. For example, the coverage feature may be calculated by dividing the number of assets covered by a discount plan by the total number of assets. In embodiments, the calculation may further include SME weight 925, a weighted coefficient (or variable) that may modify the final outcome of the formula. For example, as shown in FIG. 9, the “coverage” feature is assigned an SME weight of 0.2, which means, an SME has determined that the “coverage” feature has less importance than the “tagged assets” feature and the “optimize recommendations” feature when generating the score for the “data analysis & showback” capability.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by a computing device, a plurality of data types from an aggregation of data sources;
generating, by the computing device, at least one capability maturity score by evaluating a capability of at least one data source of the aggregation of data sources;
generating, by the computing device, at least one provider maturity score by evaluating the at least one data source of the aggregation of data sources associated with a specific provider;
generating, by the computing device using a machine learning algorithm, a set of recommendations based on a combination of the at least one capability maturity score and the at least one provider maturity score by iteratively simulating a plurality of modified capabilities and determining one or more steps to increase an operational maturity;
ranking, by the computing device, the set of recommendations based at least partially on a predicted change in the operational maturity in response to implementing the set of recommendations; and
preparing, by the computing device, a report for a user, the report comprising a determined explanation of the predicted change in the operational maturity in response to implementing the set of recommendations.

2. The computer-implemented method of claim 1, wherein the aggregation of data sources comprises one or more cloud computing environments.

3. The computer-implemented method of claim 1, further comprising segmenting, by the computing device, the plurality of data types.

4. The computer-implemented method of claim 3, wherein the segmenting the plurality of data types comprises segmenting the plurality of data types according to one or more of industry, age, and volume.

5. The computer-implemented method of claim 1, further comprising determining, by the computing device, at least one weighted contribution that correlates to the predicted change in the operational maturity in response to implementing the set of recommendations.

6. The computer-implemented method of claim 5, wherein the ranking the set of recommendations is further based on the determined at least one weighted contribution.

7. The computer-implemented method of claim 5, wherein the report for the user further comprises an explanation of how the at least one weighted contribution was assigned and how the at least one weighted contribution affects the operational maturity.

8. The computer-implemented method of claim 5, wherein the at least one weighted contribution comprises a change in one or more features of the plurality of data types.

9. The computer-implemented method of claim 1, wherein the plurality of data types comprises account data, cost data, and usage data.

10. A computer program product comprising one or more computer readable storage media having program instructions collectively stored on the one or more computer readable storage media, the program instructions executable to:
obtain a plurality of data types from an aggregation of data sources;
generate at least one capability maturity score by evaluating a capability of at least one data source of the aggregation of data sources;
generate at least one provider maturity score by evaluating the at least one data source of the aggregation of data sources associated with a specific provider;
generate, using a machine learning algorithm, a set of recommendations based on a combination of the at least one capability maturity score and the at least one provider maturity score by iteratively simulating a plurality of modified capabilities and determining one or more steps to increase an operational maturity;
rank the set of recommendations based at least partially on a predicted change in the operational maturity in response to implementing the set of recommendations; and
prepare a report for a user, the report comprising a determined explanation of the predicted change in the operational maturity in response to implementing the set of recommendations.

11. The computer program product of claim 10, wherein the aggregation of data sources comprises one or more cloud computing environments.

12. The computer program product of claim 10, wherein the program instructions are further executable to segment, the plurality of data types, and wherein the segmenting the plurality of data types comprises segmenting the plurality of data types according to one or more of industry, age, and volume.

13. The computer program product of claim 10, wherein the program instructions are further executable to determine at least one weighted contribution that correlates to the predicted change in the operational maturity in response to implementing the set of recommendations.

14. The computer program product of claim 13, wherein the ranking the set of recommendations is further based on the determined at least one weighted contribution.

15. The computer program product of claim 13, wherein the report for the user further comprises an explanation of the at least one weighted contribution.

16. The computer program product of claim 13, wherein the at least one weighted contribution comprises a change in one or more features of the plurality of data types.

17. A system comprising:
a processor, a computer readable memory, one or more computer readable storage media, and program instructions collectively stored on the one or more computer readable storage media, the program instructions executable to:
obtain a plurality of data types from an aggregation of data sources;
generate at least one capability maturity score by evaluating a capability of at least one data source of the aggregation of data sources;
generate at least one provider maturity score by evaluating the at least one data source of the aggregation of data sources associated with a specific provider;
generate, using a machine learning algorithm, a set of recommendations based on a combination of the at least one capability maturity score and the at least one provider maturity score by iteratively simulating a plurality of modified capabilities and determining one or more steps to increase an operational maturity;
rank the set of recommendations based at least partially on a predicted change in the operational maturity in response to implementing the set of recommendations; and
prepare a report for a user, the report comprising a determined explanation of the predicted change in the operational maturity in response to implementing the set of recommendations.

18. The system of claim 17, wherein the program instructions are further executable to determine at least one weighted contribution that correlates to the predicted change in the operational maturity in response to implementing the set of recommendations.

19. The system of claim 18, wherein the ranking the set of recommendations is further based on the determined at least one weighted contribution.

20. The system of claim 18, wherein the at least one weighted contribution comprises a change in one or more features of the plurality of data types.
